(19) United States
(12) Patent Application Publication
(10) Pub. No.: US 2010/0313814 A1
(43) Pub. Date: Dec. 16, 2010

(54) EXPANDABLE MODULAR PET FEEDER ASSEMBLY

(75) Inventor: Ching-Tzung HUANG, Taipei City (TW)

Correspondence Address: EGBERT LAW OFFICES, 412 MAIN STREET, 7TH FLOOR, HOUSTON, TX, 77002, US

(73) Assignee: YOUNGTICO CO., LTD., Taipei City (TW)

(21) Appl. No.: 12/484,193

(22) Filed: Jun. 13, 2009

(51) Int. Cl. A01K 1/10

(52) U.S. Cl. 119/61.5

(57) ABSTRACT

The present invention provides a pet feeder that can be assembled and expanded. The pet feeder is composed of a plurality of dishware units, and each dishware units can be used independently. Each dishware unit includes a food space, a lateral wall defined around the food space, and an embedded coupling assembly arranged at one side of the lateral wall for interlocking or snapping purpose. The dishware units can be assembled via the mating of the embedded coupling assemblies, and also removed easily. Pet owners may add the dishware units depending on the consumption and type of food. The dishware units can be connected more stably due to increase of bottom surface area, so the pet feeder can be used in an orderly and environmental-friendly manner.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a pet feeder, and more particularly to an innovative feeder which is modular and expandable.

2. Description of Related Art Including Information Disclosed Under 37 CFR 1.97 and 37 CFR 1.98.

It is common to raise a pet in modern society, and the design of pet-related articles is improved functionally when the quality of life of people increases. Hence, only through continuous breakthrough innovation could the operators of pet articles meet the diversified user requirements in the face of competitive market environment.

People often put food into certain basins (iron or plastic basins) while feeding their pets such as cats or dogs. Then the pets take food from the basins, but some problems are still encountered for the owners of pets because some non-staple food items may be supplemented, in addition to the regular food and drinking water. Thus, in response to various requirements, pet owners have to reserve several feeders for accommodating the aforementioned food, drinking water and non-staple food. Additionally, feeder bowls have bottoms that are easily pushed by the pets, and then displaced or overturned. A disorderly environment maybe caused once the feeders are scattered, leading easily to noise or even pollution. This situation becomes more serious for the owners with several pets, and surely raises serious concerns.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

There is enhanced efficacy of the present invention.

Based on the unique present invention, embedded coupling assemblies are arranged on the lateral wall of the dishware units. The dishware units can be connected and assembled via the mating of the embedded coupling assemblies, and also disassembled easily and conveniently. With the present invention, the pet owners may add the dishware units depending on the consumption and type of food. Moreover, the dishware units can be connected more stably due to an increase of bottom area stability, so the pet feeder can be used in an orderly and environmental-friendly manner.

There are improvements brought about by this invention.

From the perspective of the product value, the dishware units of the pet feeder can be interconnected via the embedded coupling assembly, and the bulges and grooves of the embedded coupling assembly can be assembled like jigsaw puzzle. In such a case, the novel and innovative pet feeder can attract the attention of the consumers, thus improving the brand value and competitiveness of the operators for better industrial and economic efficiency.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a perspective view of a single dishware unit of the pet feeder of the present invention.

FIG. 2 shows a top plan view of the present invention that several dishware units are exploded.

FIG. 3 shows a top plan view of the present invention that several dishware units are assembled.

FIG. 4 shows a perspective view of the assembly of the pet feeder of the present invention.

FIG. 5 shows a top plan view of an application with a lateral wall of the present invention being a square pattern.

FIG. 6 shows a cross-sectional view of an application of the embedded coupling assembly of the present invention which is of a dovetail pattern.

FIG. 7 shows a cross-sectional view of an application of the embedded coupling assembly of the present invention which is of expanded round-headed pattern.

FIG. 8 shows a top plan view of the present invention, having the embedded coupling assembly arranged at one side.

FIG. 9 shows another perspective view of the status of the embedded coupling assembly of the present invention.

FIG. 10 shows a top plan view of the present invention, having the lateral wall in a triangular pattern.

FIG. 11 shows a top plan view of the present invention, showing the dishware unit of different dimensions.

FIG. 12 shows a top plan view of the preferred embodiment disclosed in FIG. 11.

FIG. 13 shows a top plan view of the present invention, showing that the dishware unit can be assembled into different patterns.

### DETAILED DESCRIPTION OF THE INVENTION

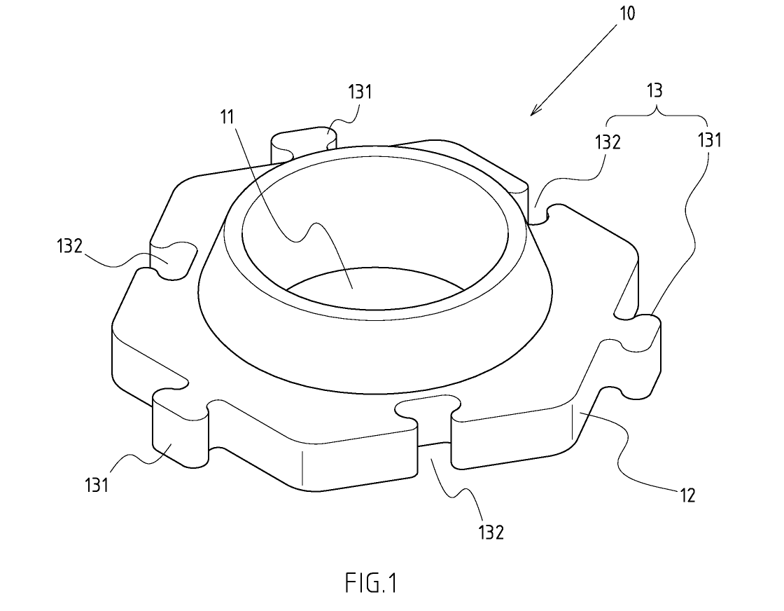

FIGS. 1-3 depict preferred embodiments of a pet feeder of the present invention enabling assembly and expansion. The embodiments are provided for only explanatory objectives with respect to the patent claims.

The pet feeder is composed generally of a plurality of dishware units 10 or a single dishware unit 10 in practice. Each dishware unit 10 comprises at least a food space 11, used for accommodating pet food such as: food, drinking water and non-staple food, a lateral wall 12, defined around the food space 11, and at least an embedded coupling assembly 13, arranged at least one side of the lateral wall 12 for embedding or snapping purposes.

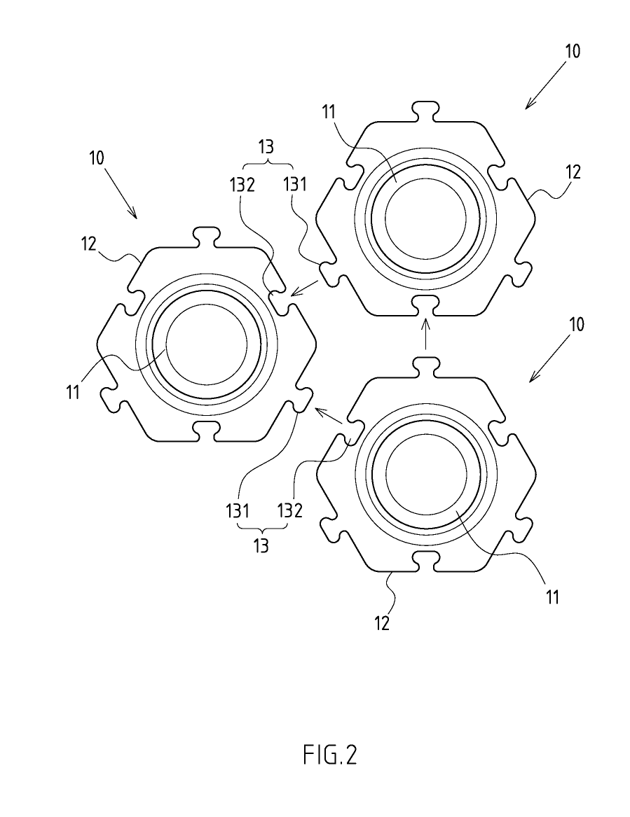

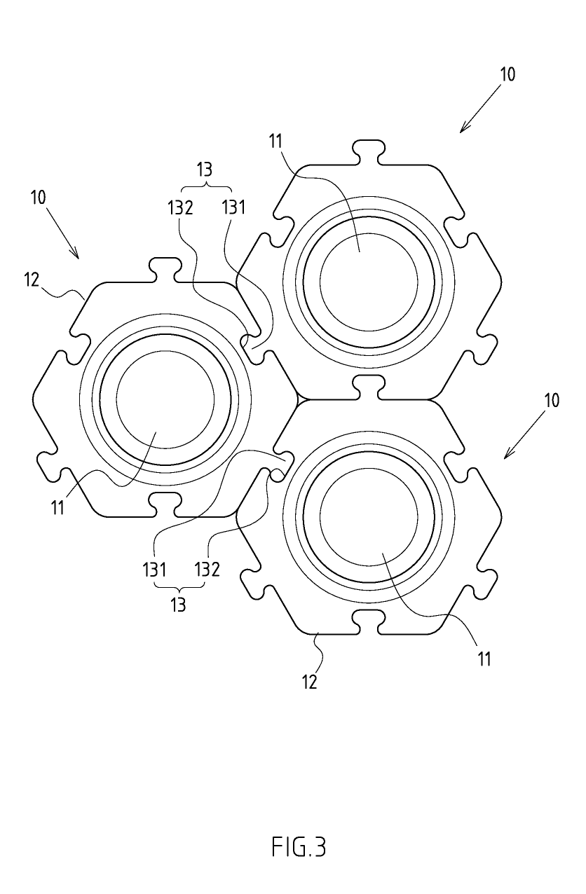

Referring to FIGS. 2 and 3, the dishware units 10 can be connected if the embedded coupling assemblies 13 are aligned or otherwise removed easily.

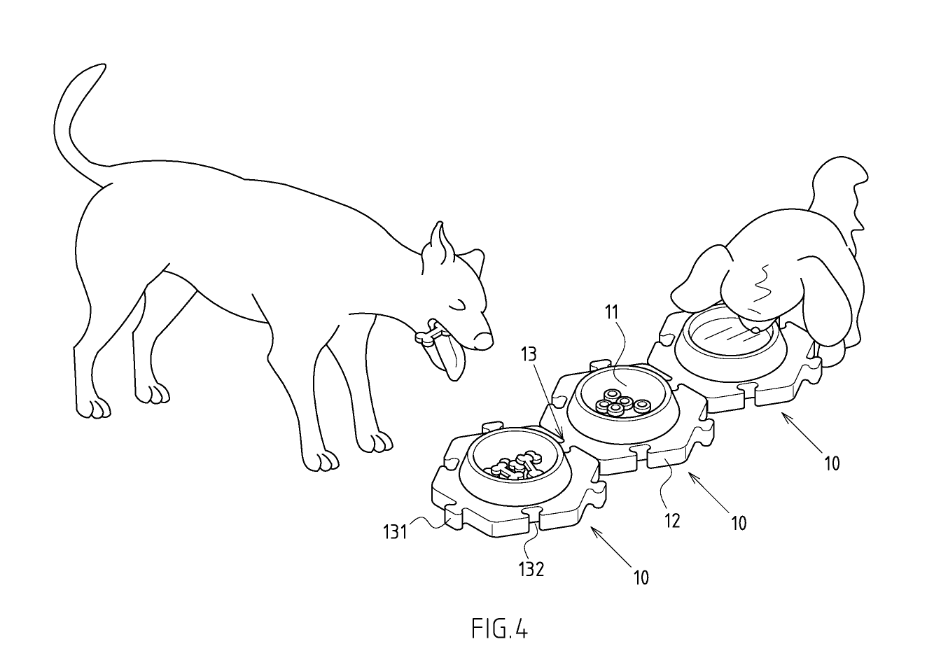

Referring to FIG. 4, the dishware units 10 of the pet feeder are assembled for the pets, wherein the dishware units 10 cannot be easily pushed or overturned by the pets since the bottom area is increased significantly along with much higher stability. This can reduce markedly the noise level and environmental pollution generated from taking food by the pets. Besides, a more disorderly and comfortable environment may occur as most of dishware units 10 can be used collectively.

The pet feeder dishware unit 10 can be made of any material such as plastic, metal, timber, porcelain and stone, by means of existing processing technology.

The lateral wall 12 can be designed into either of the following patterns: polygon, square, round and triangle. Referring to FIGS. 1-4, the lateral wall 12 of the dishware unit 10 is designed into a hexagon. Referring also to FIG. 5, the lateral wall 12B of the dishware unit 10B is designed into a square.

Said embedded coupling assembly 13 is arranged as shown in FIGS. 1-3, wherein it is composed of a plurality of embedded bulges 131 and embedded grooves 132 arranged on the lateral wall 12 at an equal interval. When these two dishware units 10 of the same structure are coupled, they can be positioned securely by the interlocking of the embedded bulges 131 and embedded grooves 132. Moreover, the multi-lateral embedded coupling assembly 13 of the preferred embodiment allows for multi-lateral extension and expansion of the dishware unit 10.

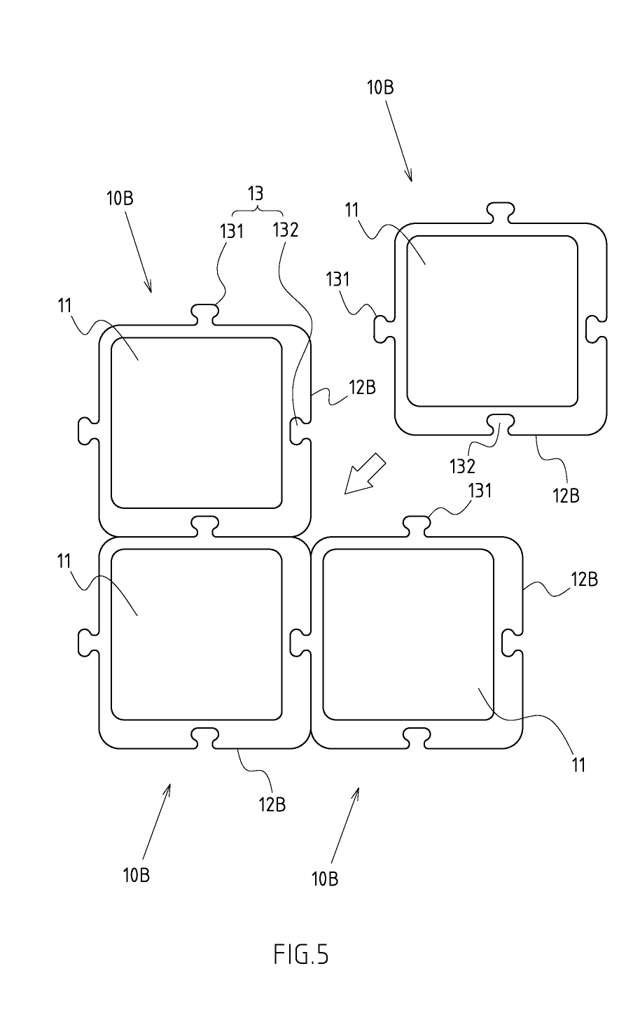

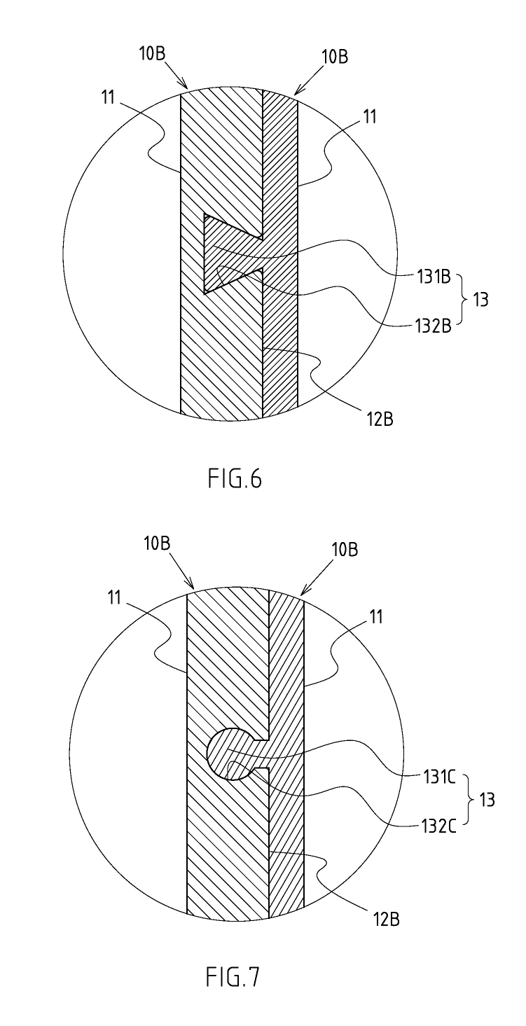

The embedded bulges 131 and embedded grooves 132 of the embedded coupling assembly 13 can be assembled into several patterns. Referring to FIGS. 1-3, the embedded bulges 131 and embedded grooves 132 are designed into a T-pattern. Referring to FIG. 6, the embedded bulges 131B and embedded grooves 132B are designed into a dovetail pattern. Referring to FIG. 7, the embedded bulges 131C and embedded grooves 132C are designed into an expanded round-headed pattern. The aforementioned embedded bulges 131 and embedded grooves 132 are extended vertically if viewing from one side of the dishware unit 10; so they can be assembled from top to down like jigsaw puzzle, making it easy for assembly and disassembly as a practical design withstanding transverse pulling force and bending force.

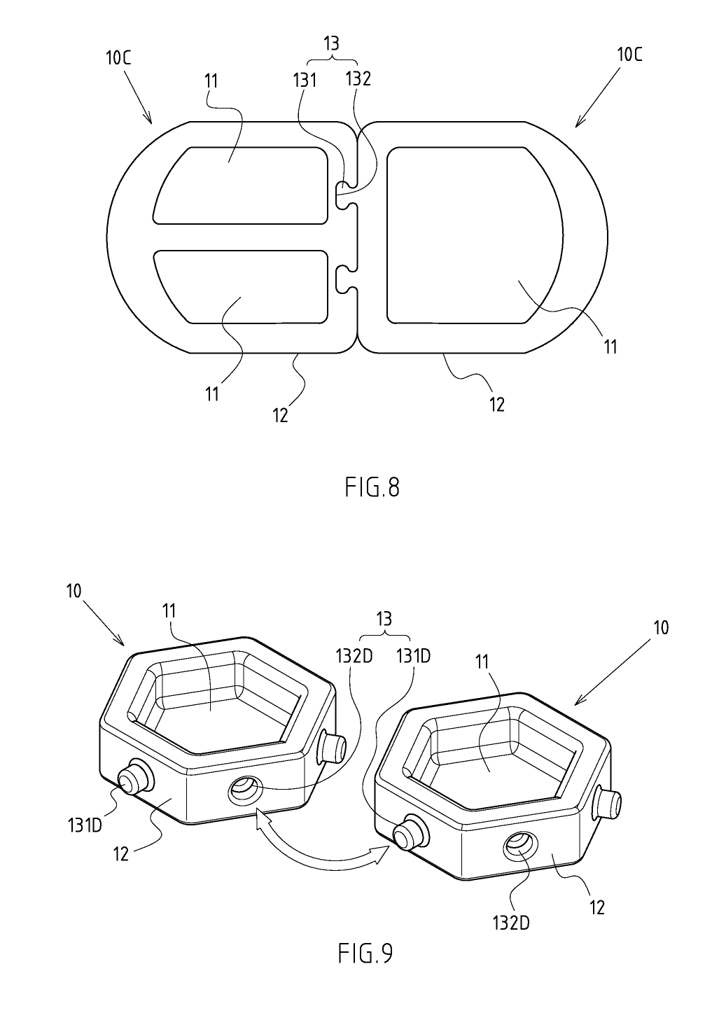

Referring also to FIG. 8, the embedded coupling assembly 13 of the dishware unit 10C can also be composed of embedded bulge 131 or embedded groove 132 arranged at one side of the lateral wall 12. The difference with the aforementioned preferred embodiments in FIGS. 1-3 lies in that this preferred embodiment is only suitable for assembly of two groups of dishware units 10 in response to the market demand. Referring also to FIG. 8, a plurality of food spaces 11 can also be placed in the single dishware unit 10.

The embedded coupling assembly 13 of the dishware unit 10C is not restricted to the patterns shown in FIGS. 1-8. Referring also to FIG. 9, the embedded bulge 131D of the embedded coupling assembly 13 is a column (circular or angular column) protruded laterally from the lateral wall 12, while the embedded groove 132D is a recessed groove (round or angular hole) mated with the embedded bulge 131D. This preferred embodiment also enables interlocking and positioning.

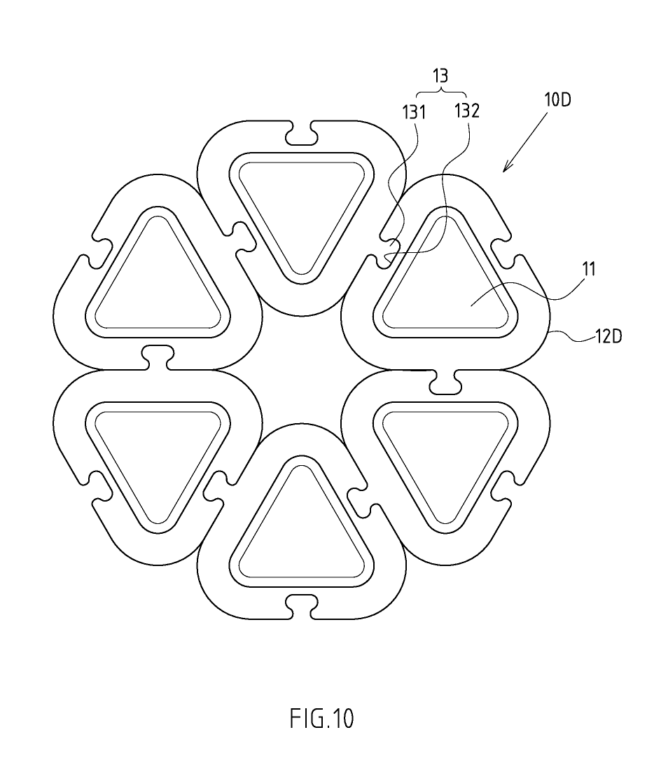

Referring to FIG. 10, the lateral wall 12D of the dishware unit 10D is of a triangular shape. Most of dishware units 10D in the preferred embodiment are designed into a circular shape suitable for a few pets.

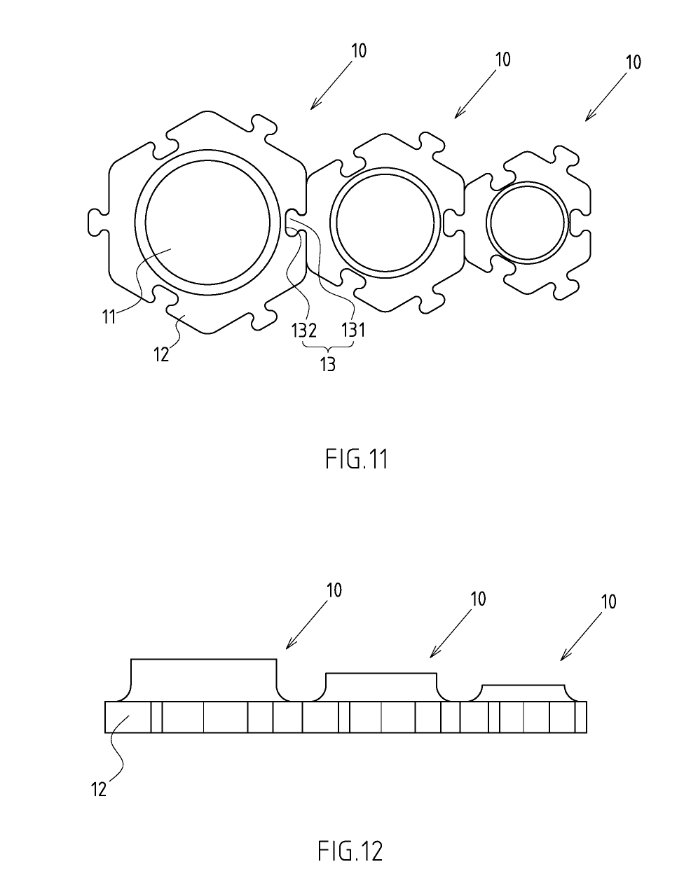

Referring also to FIGS. 11 and 12, the dishware units 10 can also be designed into some patterns of different dimensions (height, external diameter, etc), all of which can also be assembled via the same type of embedded coupling assembly 13.

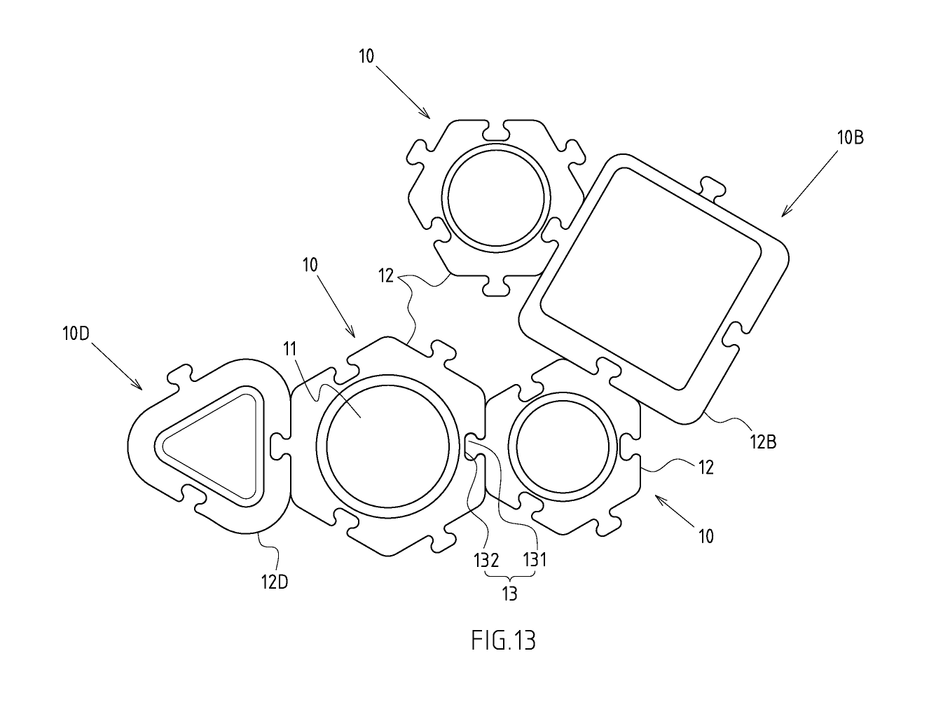

Referring to FIG. 13, the dishware units 10, 10B, 10D of different patterns can also be assembled via the same type of embedded coupling assembly 13.

1. A pet feeder comprising:
a dishware unit, said dishware unit comprising:
a food space, used for accommodating pet food;
a lateral wall, defined around the food space;
an embedded coupling assembly, arranged on one side of the lateral wall for embedding or snapping purposes;
wherein said dishware unit is mateable with an embedded coupling assembly of another dishware unit.

2. The pet feeder defined in claim 1, wherein the lateral wall is selected from a group consisting of: polygon, square, round and triangle.

3. The pet feeder defined in claim 1, wherein the embedded coupling assembly is comprised of a plurality of embedded bulges and embedded grooves arranged on the lateral wall at an equal interval.

4. The pet feeder defined in claim 1, wherein the embedded coupling assembly is comprised of embedded bulge or embedded groove arranged at one side of the lateral wall.

5. The pet feeder defined in claim 3, wherein the embedded bulge is selected from a group consisting of: T-pattern, dovetail pattern and expanded round-headed pattern, the embedded groove being mateable with the embedded bulge.

6. A pet feeder comprising:
a plurality of dishware units, each dishware unit comprising:
a food space, used for accommodating pet food;
a lateral wall, defined around the food space; and
an embedded coupling assembly, arranged on a side of the lateral wall for embedding or snapping purposes;
wherein adjacent dishware units are assembled and mated by respective embedded coupling assemblies.

7. The pet feeder defined in claim 6, wherein the lateral wall is selected from a group consisting of: polygon, square, round and triangle.

8. The pet feeder defined in claim 6, wherein the embedded coupling assembly is comprised of a plurality of embedded bulges and embedded grooves arranged on the lateral wall at an equal interval.

9. The pet feeder defined in claim 6, wherein the embedded coupling assembly is comprised of embedded bulge or embedded groove arranged at one side of the lateral wall.

10. The pet feeder defined in claim 8, wherein the embedded bulge is selected from a group consisting of: T-pattern, dovetail pattern and expanded round-headed pattern, the embedded groove being mateable with the embedded bulge.
